(19) United States
(12) Patent Application Publication
(10) Pub. No.: US 2005/0252745 A1
(43) Pub. Date: Nov. 17, 2005

(54) Dual clutch assembly for a motor vehicle powertrain

(76) Inventors: Joseph Vanselous, Highland, MI (US); David Janson, Plymouth, MI (US); Matthew Hammond, Dearborn, MI (US); Shaun Knowles, Canton, MI (US); Andy Olender, Westland, MI (US)

Correspondence Address: Frank McKenzie;MacMillan Sobanski & Todd, Suite 405, 38705 W. Seven Mile Road, Livonia, MI, 48152, US

(21) Appl. No.: 10/846,800

(22) Filed: May 14, 2004

(51) Int. Cl. F16D 21/02

(52) U.S. Cl. 192/48.8; 192/70.17; 192/200; 192/212

(57) ABSTRACT

A powertrain assembly for transmitting torque between a power source and a transmission includes an input shaft, a housing on which the input shaft is rotatably supported, a flywheel rotatably supported at two axially spaced locations, at least one of the locations providing support for the flywheel on the housing, and a clutch for driveably connecting and disconnecting the flywheel and the input shaft.

### BACKGROUND OF THE INVENTION

1. Field of the Invention

The invention relates to friction clutches. In particular the invention pertains to dual friction clutches for connecting a power source output shaft alternately to input shafts of a motor vehicle transmission.

2. Description of the Prior Art

Conventional automotive dry clutch systems are supported directly on the engine crankshaft distant from the center of mass of the system. The mass of the clutch system is cantilevered and subject to bending displacement relative to the centerline of the crankshaft. As the crankshaft rotates, the mass of the clutch system is subject to orbiting motion about the true centerline of the crankshaft. The resulting orbiting radius from the crankshaft axis and the clutch mass together induce a first order forced vibration in the powertrain, which further increases crankshaft deflection and increases load on the system.

Misalignment of the engine crankshaft centerline relative to the transmission input shaft centerline causes the surfaces of the friction discs of the clutch to wear irregularly in compliance with the misalignment. Misalignment of the clutch mass relative to the crankshaft during initial installation also contributes to the problem.

U.S. Publication US2003/0066730, dated Apr. 10, 2003, describes an example of a clutch assembly installed between a drive unit and a transmission having a transmission input shaft to transmit torque between the drive unit and the transmission. The clutch and a portion of the clutch actuation system hardware are supported on an engine crankshaft. The clutch mass is cantilevered a substantial distance from the crankshaft support across a space occupied by the clutch and its actuators.

Automotive torque converter systems conventionally are secured to the engine crankshaft with a compliant or flexible member, which allows axial and bending displacement, and are supported on the transmission by a single bushing or bearing. The partially supported cantilevered mass of the torque converter, due to bending or flexing and whirl of the crankshaft, rotates in an orbiting motion about the true centerline of the crankshaft. The resulting orbit radius and the torque converter mass induce a first order vibration in the powertrain, which increases the crankshaft deflection and resulting loads. But misalignment of the engine crankshaft centerline relative to the transmission input shaft centerline is accommodated by compliance within a compliant, flexible member located in a torque-transmitting path between the crankshaft and torque converter. Misalignment of the torque converter mass relative to the crankshaft during installation and misalignment of the transmission support relative to the engine crankshaft centerline contribute to the vibration.

There is need to support the rotating clutch mass on a secure surface, preferably a surface that is aligned with the axis of the crankshaft axis. The support should substantially reduce or eliminate displacement of the clutch mass relative to the axis of rotation during installation and in service. The structural support preferably would eliminate the cantilevered nature of the support currently provides to the clutch mass. Instead, the weight of the clutch assembly would be supported at both opposite axial sides of the rotating clutch mass.

### SUMMARY OF THE INVENTION

In the clutch assembly according to this invention, the entire clutch system mass is fully supported by two bearings mounted on the transmission housing. This mounting technique provides a stable support for the clutch system free from the effects of crankshaft whirl and misalignment of the crankshaft relative to the transmission. Powertrain noise, vibration and harshness is improved due to the reduction in first order imbalance forces.

Engine power is transmitted to the clutch system by a flexible coupling that allows for radial and angular misalignment of the engine crankshaft relative to the clutch system. The flexible coupling, however, does provide sufficient axial strength to transmit clutch actuation forces to a crankshaft thrust bearing as well as to transmit torque between the crankshaft and the clutch.

In one embodiment, two axially spaced bearings that support the clutch mass on the transmission housing are located on an axial side of the clutch near the housing. In this way, the clutch mass is provided with two axially spaced bearings that rotatably support the clutch mass, which is overhung from those spaced bearings. In another embodiment, the rotating clutch mass is provided again with two axially spaced supports. One support is a bearing mounted on the transmission housing at one axial side of the clutch center of mass. The other support is a radial disc piloted on a surface of the crankshaft and located at the opposite side of the center of mass from the location of the bearing support. Neither technique for supporting the clutch mass requires the center of mass to be cantilevered from the transmission housing or from the engine crankshaft, thereby preventing the orbiting eccentricity that a cantilevered support arrangement produces.

A powertrain assembly according to this invention for transmitting torque between a power source and a transmission includes an input shaft, a housing on which the input shaft is rotatably supported, a bearing supported on the housing, and a flywheel rotatably supported at two axially spaced locations. At least one of the locations is at the bearing, which is located at a side of the flywheel, and provides support for the flywheel on the housing. A clutch driveably connects and disconnects alternately the flywheel and the input shaft.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a side elevation view, partially in cross section, showing a dual dry clutch assembly arranged in a drive path on which torsion is transmitted between an engine crankshaft and two transmission input shafts; and

FIG. 2 is a side elevation view, partially in cross section, showing another embodiment of the dual dry clutch according to this invention.

### DETAILED DESCRIPTION OF THE PREFERRED EMBODIMENT

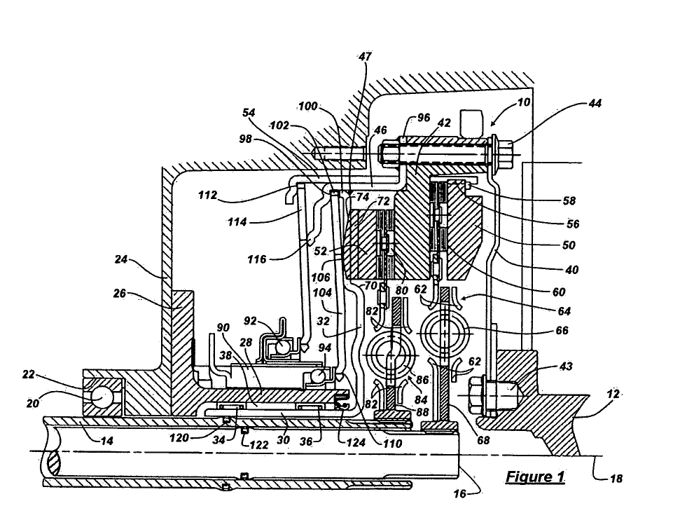

Referring now to the drawings, there is illustrated in FIG. 1 a dual clutch assembly 10 for transmitting power between an engine crankshaft 12 and first and second input shafts 14, 16 alternately. Shaft 12 may be an output shaft driven by an electric motor or hydraulic motor. Input shaft 14 is a sleeve shaft. Input shaft 16 is a solid shaft coaxial with shaft 12 and located within the sleeve shaft along at least a portion of its length. The input shafts are driveably connected to gearing that produces various ratios of the speed of a transmission output shaft and the speed of the input shafts. The dual clutch assembly and the input shafts are arranged about a longitudinal axis 18.

The crankshaft 12 is supported for rotation on bearings (not shown) located in the engine block. The input shafts 14, 16 are rotatably supported on a clutch support bearing 20, which is pressed into a recess 22 formed in a transmission housing 24, in which the gearing, shafts, synchronizers and other control elements of the transmission are located. The transmission 24 and engine block are supported on the chassis of the vehicle.

A front support 26, secured to the transmission housing 24, includes an axial projection 28, which overlaps an axial leg 30 formed on a clutch support disc 32. Additional rotary support is provided to the assembly 10 by bearings 34, 36, which are mutually spaced axially and pressed into an annular space 38 located between the axial legs 28, 30 of the front support 26 and clutch support disc 32, respectively.

The crankshaft 12 carries a flex plate 40, which transmits torque to a flywheel 42 through a bolted connection 43 to the crankshaft and a bolted connection 44 to the flywheel. Bolts 44 are spaced angularly about axis 18 at the outer periphery of flex plate 40 and flywheel 42. The flex plate 40 deflects readily along the axis 18 to accommodate axial movement of the flywheel relative to the crankshaft, but the flex plate transmits torque in a relatively stiff plane normal to axis 18. The bolts 44 also engages the flywheel 42 and secures a pressure plate cover 46 to the flywheel, flex plate 40 and crankshaft 12. The pressure plate 46 is welded at 47 to the clutch support disc 32, which is supported about axis 18 on bearings 34, 36. In this way, the flywheel 42 and the two clutches are supported at opposite axial ends on the crankshaft 12 and transmission housing 24.

The flywheel is located axially between a first pressure plate 50 and a second pressure plate 52. The first pressure plate 50 is rotatably connected to an apply cylinder 54 by a spline 56, formed on the radially outer periphery of pressure plate 50. The spline 56 permits axial displacement of pressure plate 50 relative to flywheel 42. A snap ring 58, fitted in a recess in the apply cylinder 54, secures the cylinder to the pressure plate 50 so that cylinder 54 and pressure plate 50 move axially as a unit. Pressure plates 50 and 52 are attached and driveably connected to flywheel 42 by drive straps or drive links (not shown) so that pressure plates 50, 52 rotate as a unit with flywheel 42. The drive links or drive straps are of the type conventionally used for this purpose in a dual clutch assembly for a motor vehicle powertrain.

A first clutch, which preferably includes a clutch disc 60 but may include a stack of thin clutch discs located in an space located in an space between the flywheel 42 and pressure plate 50, is driveably connected to a housing 62 of a torsion damper 64 containing helical coiled compression springs 66, which are arranged in a annular space around axis 18 surrounded by the housing 62. A radially directed damper plate 68, secured by splines to input shaft 16, extends radially into a space between adjacent damper springs 66, and is located close to an end of each adjacent spring. Torsional displacement of the clutch disc 60 relative to input shaft 16 causes the housing 62 and springs 66 to rotate relative to the plate 68. The springs contact the damper plate, are compressed due to this contact, and frictionally engage the damper housing 62 as they compress. In this way, the damper 64 stores torsional energy in the springs and dissipates through friction some of the torsional energy transmitted between the clutch disc 60 and input shaft 16. Torsion damper 64 connects clutch disc 60 and input shaft 16, and attenuates torsional vibrations between those components.

A second clutch, which preferably includes a clutch disc 80 but may include a stack of thin clutch discs located in an space between the flywheel 42 and pressure plate 52, is driveably connect to a housing 82 of a torsion damper 84 containing helical coiled compression springs 86, which are arranged in a annular space around axis 18 surrounded by the housing 82. A radially directed damper plate 88, secured by a spline to input shaft 14, extends radially into a space between adjacent damper springs 86. The torsion damper 84 connects clutch disc 80 and input shaft 14, and attenuates torsional vibrations between those components.

An apply bearing support 90, mounted on the axial arm 28 of the front support 26, carries a first throw-out bearing 92 and provides an outer race for a second throw-out bearing 94. Preferably the throw-out bearings 92, 94 are electro-mechanically actuated to apply and release alternately the first and second clutch.

The pressure plate cover 46 includes a radial leg 96, which is engaged by bolt 44 and secured to the flywheel 42. Pressure plate cover 46 is formed with an annular bead 98. Clutch support disc 32 is formed with an annular lip 100, located at its radial periphery, and spaced a sport axial distance from bead 98. The radial end 102 of a clutch apply lever 104 is fitted in the space between bead 98 and lip 100. Pressure plate 52 is formed with an annular protrusion 106, which extends through radial slots in clutch support disc 32 and contacts the adjacent surface of apply lever 104. The radial inner periphery of lever 104 is formed with an annular bead 110, which contacts throw-out bearing 94.

Similarly, clutch apply cylinder 54 includes an annular bead 112, which contacts the radial periphery of a second clutch apply lever 114. Pressure plate cover 46 is formed with another annular bead 116, which is held in contact with a surface of the second clutch apply lever 114. The radial inner periphery of clutch apply lever 114 is held in contact with throw-out bearing 92.

Clutch apply levers 104, 114 are preferably Belleville springs formed and located as described. The elastically resilient nature of the levers 104, 114 maintains them in contact with the surfaces of the apply cylinder 54, pressure plate cover 46, and pressure plate 52, clutch support disc 32, and the throw-out bearings 92, 94.

In operation, the clutch disc 60 is engaged by applying a force to throw-out bearing 92 that has an axial component directed rightward. In response to this actuating force, clutch apply lever 114 applies at bead 112 an axial force directed leftward to apply cylinder 54, due to its supported contact with bead 116. Cylinder 54 transmits the leftward directed axial force to pressure plate 50, causing the clutch disc 60 frictionally to engage both the flywheel 42 and pressure plate 50 and engaging the clutch. When the actuating force is removed from throw-out bearing 92, frictional engagement of the clutch disc with the flywheel 42 and pressure plate 50 is discontinued, and the clutch disengages.

The clutch disc 80 is engaged by applying a rightward force to throw-out bearing 94. That actuating force is reacted by a leftward axial force applied to bead 98 on clutch apply lever 54 and a rightward axial force applied to protrusion 106 on pressure plate 52. The reaction force on pressure plate forces the clutch disc 80 frictionally to engage both the flywheel 42 and pressure plate 52, thereby engaging the clutch. When the actuating force is removed from throw-out bearing 94, frictional engagement of the clutch disc 80 with the flywheel 42 and pressure plate 52 is discontinued, and the clutch disengages.

The space occupied by the clutches 60, 80 is sealed from the interior of the transmission housing 24 against the passage of lubricating oil, automatic transmission fluid, by several seals. Seal 120 is fitted in a recess on the outer surface of input shaft and contacts the axial leg 30 of clutch support disc 32. Seal 122 is fitted in a space between the inner surface of input shaft 14 and the outer surface of input shaft 16. Seal 124 seals the space between the radially outer surface of the axial leg 30 of the clutch support disc 32 and the front support 26.

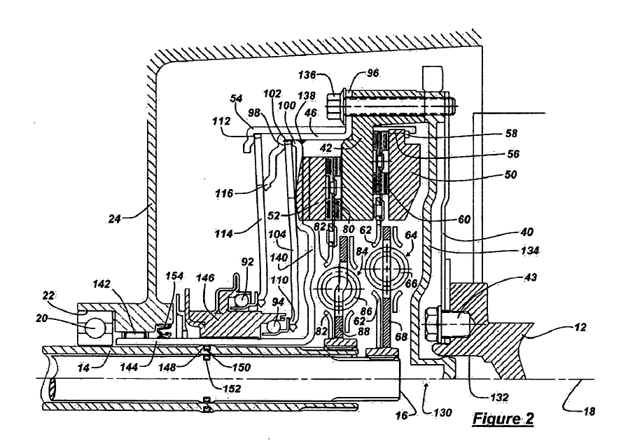

In FIG. 2 components identical to those of FIG. 1 are assigned the same reference number. In the arrangement of FIG. 2, a flywheel support 130 is piloted on a radially inner surface 132 of the crankshaft 12, which is aligned with the crankshaft axis. Flywheel support 130 includes a partial spherical radius, which contacts surface 132 with contact along a circular line on which only a force can be developed but no bending moment. This piloted engagement of support on the crankshaft 12 ensures concentric alignment of the crankshaft axis with the axis of the concentric input shafts 14, 16. The input shafts 14, 16 are rotatably supported on the clutch support bearing 20, which is pressed into a recess 22 formed a transmission housing 24.

The flywheel support 130 includes a disc 134, which extends radially from axis 18 and is engaged by the threads of bolts 136, spaced angularly about axis 18 at the outer periphery of support 130 and flywheel 42. The flex plate 40, flywheel 42 and pressure plate cover 46 are engaged also by bolts 136. The pressure plate cover is welded at 138 to a clutch support disc 140, which is supported about axis 18 on bearing 142, pressed into a space between the axial leg 144 of the clutch support disc 140 and the transmission housing 24.

The leg 144 of clutch support disc 140 contacts the outer surface of input shaft 14 at a land 148 formed with a recess containing a fluid seal 150. Another fluid seal 152 is similarly retained in a recess formed in a land on the outer surface of input shaft 16. Seals 150 and 152 prevent the passage of ATF from the transmission housing 24 into the space occupied by the two dry clutches. Another fluid seal 154, having a similar purpose, seals the space between the clutch support disc and the transmission housing 24.

In the manner described with reference to FIG. 1, clutch disc 80 is frictionally engaged with the flywheel 42 and pressure plate 52 in response to rightward axial displacement of throw-out bearing 94 and a rightward axial force applied by clutch apply lever 104 to pressure plate 52 upon employing the restrain applied to lever 104 at its radially outer periphery 102. The clutch disc 60 of the other clutch is frictionally engaged with the flywheel 42 and pressure plate 50 in response to rightward axial displacement of throw-out bearing 92. The actuating force applied to bearing 92 is applied as a leftward axial force to pressure plate 50 by clutch apply cylinder 54 upon employing the restrain applied to clutch apply lever 114 by pressure plate cover 46 at 116.

Each clutch is disengaged by removing the actuating force from its corresponding throw-out bearing 92, 94. The clutch apply levers 104, 114 are formed of Belleville springs, which deflect and develop a resilient elastic force when the actuating forces are applied to the bearings 92, 94. When the actuating forces are removed, the clutch apply levers 104, 114 are released and return immediately to the neutral, unactuated positions of FIGS. 1 and 2, allowing the respective clutch to disengage.

The transmission whose input shafts are driveably connected by the clutches may be a transmission having multiple layshafts or countershafts, each associated with an alternate speed ratio produced by the transmission. To produce each speed ratio, a synchronizer or coupler prepares a drive path associated with the oncoming speed ratio, one input clutch is engaged, the other input clutch is disengaged, and a synchronizer decouples the offgoing speed ratio. A transmission of this type is described in U.S. Pat. No. 4,463,621, dated Aug. 7, 1984, which is assigned to the Assignee of the present invention. The entire disclosure of U.S. Pat. No. 4,463,621 is incorporated herein by reference.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. Apparatus for transmitting torque between a power source and a transmission, comprising:
a first transmission input shaft;
a transmission housing on which the input shaft is rotatably supported;
a flywheel rotatably supported at two axially spaced locations, at least one of said locations providing support for the flywheel on the transmission housing; and
a first clutch for driveably connecting and disconnecting the flywheel and the first transmission input shaft.

2. The apparatus of claim 1, further comprising:
a second transmission input shaft coaxial with the first input shaft; and
a second clutch for driveably connecting and disconnecting the flywheel and second transmission input shaft.

3. The apparatus of claim 1, further comprising:
an output shaft driven by the power source;
a flywheel support disc located on a first axial side of the flywheel, secured to the flywheel, secured to the output shaft for alignment with an axis of the output shaft; and
a clutch support disc secured to the flywheel at a side of the first clutch axially opposite the first side, and rotatably supported on the transmission housing.

4. The apparatus of claim 1, further comprising:
an output shaft driven by the power source;
a flywheel support disc secured to the flywheel, contacting and supported on the output shaft at a first axial side of the flywheel for piloted alignment with an axis of the output shaft;
a first bearing supported on the transmission housing at a second side of the first clutch opposite the first side; and
a clutch support disc secured to the flywheel at the second side, and rotatably supported on the transmission housing at the first bearing.

5. The apparatus of claim 1, further comprising:
an output shaft driven by the power source, formed with a guide surface aligned with an axis of the output shaft;
a flywheel support disc secured to the flywheel, formed with an annular surface having at least a partial spherical radius contacting the guide surface at a first axial side of the flywheel for piloted alignment with an axis of the output shaft;
a first bearing supported on the transmission housing at a second side of the first clutch opposite the first side; and
a clutch support disc secured to the flywheel at a side of the first clutch axially opposite the first side, and rotatably supported on the transmission housing at the first bearing.

6. The apparatus of claim 1, further comprising:
a first bearing supported on the transmission housing and located at a first axial side of the flywheel;
a second bearing supported on the transmission housing, spaced axially from the first bearing, and located at the first side of the flywheel;
a clutch support disc secured to the flywheel, and rotatably supported on the transmission housing at the first bearing and the second bearing.

7. The apparatus of claim 1, further comprising:
an output shaft driven by the power source;
a first bearing supported on the transmission housing and located at a first axial side of the flywheel;
a second bearing supported on the transmission housing, spaced axially from the first bearing, and located at the first side of the flywheel;
a clutch support disc secured to the flywheel, and rotatably supported on the transmission housing at the first bearing and the second bearing; and
a flex plate secured to the flywheel at a second side of the flywheel axially opposite the first side to prevent angular displacement of the flywheel relative to the flex plate, and to permit axial and radial displacement of the flywheel relative to the flex plate.

8. The apparatus of claim 1, further comprising:
an output shaft driven by the power source;
a flywheel support disc secured to the flywheel, contacting and supported on the output shaft at a first axial side of the flywheel for piloted alignment with an axis of the output shaft;
a first bearing supported on the transmission housing at a second side of the first clutch opposite the first side; and
a clutch support disc secured to the flywheel, and rotatably supported on the transmission housing at the first bearing; and
a flex plate secured to the flywheel at the first side of the flywheel to prevent angular displacement of the flywheel relative to the flex plate, and to permit axial and radial displacement of the flywheel relative to the flex plate.

9. The apparatus of claim 1, further comprising:
a first torsion damper driveably connected to the first input shaft and the first clutch.

10. The apparatus of claim 1, further comprising:
a second transmission input shaft;
a second clutch for driveably connecting and disconnecting the flywheel and second transmission input shaft;
a first torsion damper driveably connected to the first input shaft and the first clutch; and
a second torsion damper driveably connected to the second input shaft and the second clutch.

11. The apparatus of claim 1, wherein the first clutch further comprises:
a first pressure plate supported for displacement relative to the flywheel;
a first clutch disc located between the flywheel and the first pressure plate, for frictionally engaging and disengaging the flywheel and the first pressure plate, in response to displacement of the first pressure plate; and
a first mechanism for displacing the first pressure plate relative to the flywheel.

12. The apparatus of claim 1, wherein the first clutch further comprises:
a first pressure plate supported for displacement relative to the flywheel;
a first clutch disc located between the flywheel and the first pressure plate, for driveably engaging and disengaging the flywheel and the first pressure plate in response to displacement of the first pressure plate; and
a first mechanism for displacing the first pressure plate relative to the flywheel; and
further comprising a second clutch that includes
a second pressure plate supported for displacement relative to the flywheel;
a second clutch disc located between the flywheel and the second pressure plate, for driveably engaging and disengaging the flywheel and the second pressure plate in response to displacement of the second pressure plate; and
a second mechanism for displacing the second pressure plate relative to the flywheel.

13. The apparatus of claim 12, further comprising:
a first torsion damper driveably connected to the first input shaft and the first clutch disc; and
a second torsion damper driveably connected to the second input shaft and the second clutch disc.

14. A powertrain, comprising:
a first and second input shafts;
a housing on which the first and second input shafts are rotatably supported;
a first bearing supported on the transmission housing;
a flywheel rotatably supported at two axially spaced locations, at least one of said locations being the first bearing, located at a first side of the flywheel, and providing support for the flywheel on the housing;
a first clutch for driveably connecting and disconnecting the flywheel and the first input shaft; and
a second clutch for driveably connecting and disconnecting the flywheel and the second input shaft.

15. The powertrain of claim 14, further comprising:
an output shaft driven by a power source;
a flywheel support disc located on a second side of the flywheel axially opposite the first side, secured to the flywheel, secured to the output shaft for alignment with an axis of the output shaft; and
a clutch support disc secured to the flywheel, and rotatably supported on the transmission housing.

16. The powertrain of claim 14, further comprising:
an output shaft driven by a power source;
a flywheel support disc secured to the flywheel, contacting and supported on the output shaft at a second axial side of the flywheel opposite the first side for piloted alignment with an axis of the output shaft; and
a clutch support disc secured to the flywheel at the first side, and rotatably supported on the housing at the first bearing.

17. The powertrain of claim 14, further comprising:
an output shaft driven by a power source, formed with a guide surface aligned with an axis of the output shaft;
a flywheel support disc secured to the flywheel, formed with an annular surface having a spherical radius contacting the guide surface at a second side of the flywheel axially opposite the first side for piloted alignment with an axis of the output shaft; and
a clutch support disc secured to the flywheel at the first side, and rotatably supported on the transmission housing at the first bearing.

18. The powertrain of claim 14, further comprising:
a second bearing supported on the transmission housing, spaced axially from the first bearing, and located at the first side of the flywheel; and
a clutch support disc secured to the flywheel, and rotatably supported on the transmission housing at the first bearing and the second bearing.

19. The powertrain of claim 14, further comprising:
an output shaft driven by a power source;
a second bearing supported on the transmission housing, spaced axially from the first bearing, and located at the first side of the flywheel;
a clutch support disc secured to the flywheel, and rotatably supported on the transmission housing at the first bearing and the second bearing; and
a flex plate secured to the flywheel at a second side of the flywheel axially opposite the first side to prevent angular displacement of the flywheel relative to the flex plate, and to permit axial and radial displacement of the flywheel relative to the flex plate.

20. The powertrain of claim 14, further comprising:
an output shaft driven a power source;
a flywheel support disc secured to the flywheel, contacting and supported on the output shaft at the first axial side of the flywheel for piloted alignment with an axis of the output shaft;
a clutch support disc secured to the flywheel, and rotatably supported on the transmission housing at the first bearing; and
a flex plate secured to the flywheel at the first side of the flywheel to prevent angular displacement of the flywheel relative to the flex plate, and to permit axial and radial displacement of the flywheel relative to the flex plate.

21. The powertrain of claim 14, further comprising:
a first torsion damper driveably connected to the first input shaft and the first clutch; and
a second torsion damper driveably connected to the second input shaft and the second clutch.

22. The powertrain of claim 14, wherein the first clutch further comprises:
a first pressure plate supported for displacement relative to the flywheel;
a first clutch disc located between the flywheel and the first pressure plate, for frictionally engaging and disengaging the flywheel and the first pressure plate, in response to displacement of the first pressure plate; and
a first mechanism for displacing the first pressure plate relative to the flywheel.

23. The powertrain of claim 14, wherein the first clutch further comprises:
a first pressure plate supported for displacement relative to the flywheel;
a first clutch disc located between the flywheel and the first pressure plate, for driveably engaging and disengaging the flywheel and the first pressure plate in response to displacement of the first pressure plate; and
a first mechanism for displacing the first pressure plate relative to the flywheel; and
further comprising a second clutch that includes
a second pressure plate supported for displacement relative to the flywheel;
a second clutch disc located between the flywheel and the second pressure plate, for driveably engaging and disengaging the flywheel and the second pressure plate in response to displacement of the second pressure plate; and
a second mechanism for displacing the second pressure plate relative to the flywheel.

24. The powertrain of claim 23, further comprising:
a first torsion damper driveably connected to the first input shaft and the first clutch disc; and
a second torsion damper driveably connected to the second input shaft and the second clutch disc.
